(19) United States
(12) Patent Application Publication
(10) Pub. No.: US 2010/0127846 A1
(43) Pub. Date: May 27, 2010

(54) SHIFT LEVER POSITION ALARM

(75) Inventors: Jennifer Mahaffy, Tipton, MI (US); Jessica Marie Young, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/276,211

(22) Filed: Nov. 21, 2008

(51) Int. Cl. B60Q 1/00

(52) U.S. Cl. 340/456

(57) ABSTRACT

A gear range selector for a motor vehicle having an automatic transmission with more than one forward moving gear range is provided. The gear range selector provides a driver and/or an occupant of the motor vehicle with an alert signal that a shift lever has been moved from a Drive gear range position to another forward movement gear range position.

### FIELD OF THE INVENTION

The present invention is related to an alarm, and in particular to an alarm that alerts an occupant of a motor vehicle when a shift lever is moved from a Drive position to a lower gear position and/or a sequential gear position.

### BACKGROUND OF THE INVENTION

Many motor vehicles use an automatic transmission with a plurality of transmission ranges that afford for the forward and rearward movement of the vehicle. The transmission ranges are typically a P-range (parking range), an R-range (reverse range), a N-range (neutral range) and one or more forward movement ranges. For example, the forward movement ranges can include a D-range (drive range), 4^{th}-gear range, 3^{rd}-gear range, 2^{nd}-gear range, 1^{st}-gear range, S-range (slow range) and the like. In addition, a sequential range can be provided by the automatic transmission, the sequential range consisting of a range where the gear of the transmission is selected in order and direct access to a specific gear is not possible. Stated differently, a shift lever is placed into the sequential gear range and higher or lower gears are selected by moving the shift lever in a positive or negative direction, respectively.

It is not unusual, for a gear selector plate to be present that visibly and/or physically aids a driver of the motor vehicle in placing the shift lever in a desired transmission range. However, the shift lever can be undesirably moved to a different transmission range than normally used for driving the motor vehicle. For example, the shift lever can be accidentally nudged from the D-range to a lower forward moving range and/or a sequential range. When such an event occurs, a driver of the motor vehicle may or may not notice that the shift lever has been moved. If the driver does not notice that the shift lever has been moved from the D-range to a lower forward moving range and/or the sequential range, the motor vehicle can be operated in a fuel inefficient manner. In addition, the driver may assume that the vehicle is not operating properly, thereby causing stress and/or inconvenience. As such, a device that would alert the driver of the movement of the shift lever from the D-range to a lower forward moving gear range and/or a sequential gear range would be desirable.

### SUMMARY OF THE INVENTION

A gear range selector for a motor vehicle having an automatic transmission with more than one forward moving gear range is provided. The gear range selector provides a driver and/or an occupant of the motor vehicle with an alert signal that a shift lever has been moved from a Drive gear range position to another forward movement gear range position.

The gear range selector can include a gear selector plate that has a Drive gear range position and at least one other forward movement gear range position. In addition, the gear range selector includes a shift lever that is proximate to the gear selector plate, the shift lever being operable to be placed into the Drive gear range position or one of the other forward movement gear range positions. An alarm is also included, the alarm being operable to alert the driver and/or occupant of the motor vehicle when the shift lever is placed into one of the other forward movement gear range positions. In some instances, a sensor is provided that detects when the shift lever is placed into one of the other forward movement gear range positions. As such, the alarm is energized when the sensor detects that the shift lever has been placed into one of the other forward movement gear range positions. The alarm can be an audible alarm and/or a visual alarm.

In some instances, an electronic control unit can be included and have logic incorporated therein such that a sequence of events is required before the alarm is energized. For example, if the shift lever is moved from the Park range position, Neutral range or position Reverse range position to one of the other forward movement gear range positions, then the alarm is not energized. In contrast, when the motor vehicle is moving and the shift lever has been moved from the Drive gear range position to one of the other forward movement gear range positions, the alarm is energized.

The at least one other forward movement gear range positions can include a 5^{th}-gear range, 4^{th}-gear range, 3^{rd}-gear range, 2^{nd}-gear range, 1^{st}-gear range, Slow range, Low range, Sequential range, Sequential Down range, Sequential Up range and combinations thereof. The alarm can also be energized for a predetermined amount of time, a predetermined amount of time and again at regular time intervals, until the shift lever has been placed into the Drive gear range position and/or until a manual override of the alarm has been activated.

### BRIEF DESCRIPTION OF THE DRAWINGS

FIG. 1 is a perspective view of a gear range selector according to an embodiment of the present invention wherein a shift lever is located in a Drive gear range position;

FIG. 2 is the embodiment of FIG. 1 illustrating the shift lever being moved from the Drive gear range position to a lower gear range position;

FIG. 3 is a top view of another embodiment of the present invention wherein the shift lever is in the Drive gear range position;

FIG. 4 is the embodiment of FIG. 3 illustrating the shift lever being moved from the Drive gear range position to a Sequential gear range position;

FIG. 5 is a schematic diagram of an embodiment of the present invention;

FIG. 6 is a schematic diagram of another embodiment of the present invention;

FIG. 7 is a schematic diagram of another embodiment of the present invention; and

FIG. 8 is a schematic diagram for an illustrative logic that can be included within an electronic control unit of an embodiment of the present invention.

### DETAILED DESCRIPTION OF THE INVENTION

The present invention is a gear range selector that alerts a motor vehicle driver and/or occupant a shift lever has been moved from a Drive gear range position to a different forward moving gear range position. As such, the gear range selector has utility as a component for a motor vehicle.

The gear range selector provides an alarm that alerts the driver and/or occupant when the shift lever of a transmission system for the motor vehicle is moved from the Drive gear range position (hereafter also referred to as ‘Drive’ or ‘D’) to at least one other forward movement gear range position (hereafter also referred to as ‘Drive-i’ or ‘D-i’). The alarm can be an audible alarm and/or a visual alarm. The gear range selector can include a gear selector plate that has a plurality of gear range positions, illustratively including positions for Park, Reverse, Neutral, Drive and one or more Drive-i positions. It is appreciated that the one or more Drive-i positions can include a 5^{th}-gear range, 4^{th}-gear range, 3^{rd}-gear range, 2^{nd}-gear range, 1^{st}-gear range, Slow range, Low range, Sequential range, Sequential Down range, Sequential Up range, combinations thereof and the like.

A shift lever is proximate to the gear selector plate and optionally may extend at least partially through the gear selector plate, the shift lever being operable to be placed into Drive or one of the other Drive-i positions. When the shift lever is moved from Drive to one of the Drive-i positions, the alarm can be energized and thereby alert the driver and/or occupant that such an event has taken place. The alarm can be energized for a predefined time period, thereafter again at regular time intervals, until the shift lever is placed back in Drive and/or until a manual override of the alarm is activated.

A sensor can also be included, the sensor being operable to detect when the shift lever is placed into one of the Drive-i positions. In addition, an electronic control unit (ECU) can be included, the ECU being operable to accept signals from the sensor and/or the transmission of the motor vehicle and afford energizing of the alarm when a specified sequence of events occurs. For example, the ECU can determine if the shift lever is in one of the Drive-i positions and whether or not a manual override of the alarm and/or the sensor has been activated. If the shift lever is not in one of the Drive-i positions, or the manual override has been activated, the alarm is not energized. In the alternative, if the shift lever is in one of the Drive-i positions, and the manual override has not been activated, the ECU can afford for the alarm to be energized. In addition, the ECU can afford for the alarm to be energized for a predefined time, for a predefined time period followed by re-energizing the alarm again at regular time intervals, until the shift lever is placed back into the Drive position and/or until the manual override of the sensor and/or alarm has been activated.

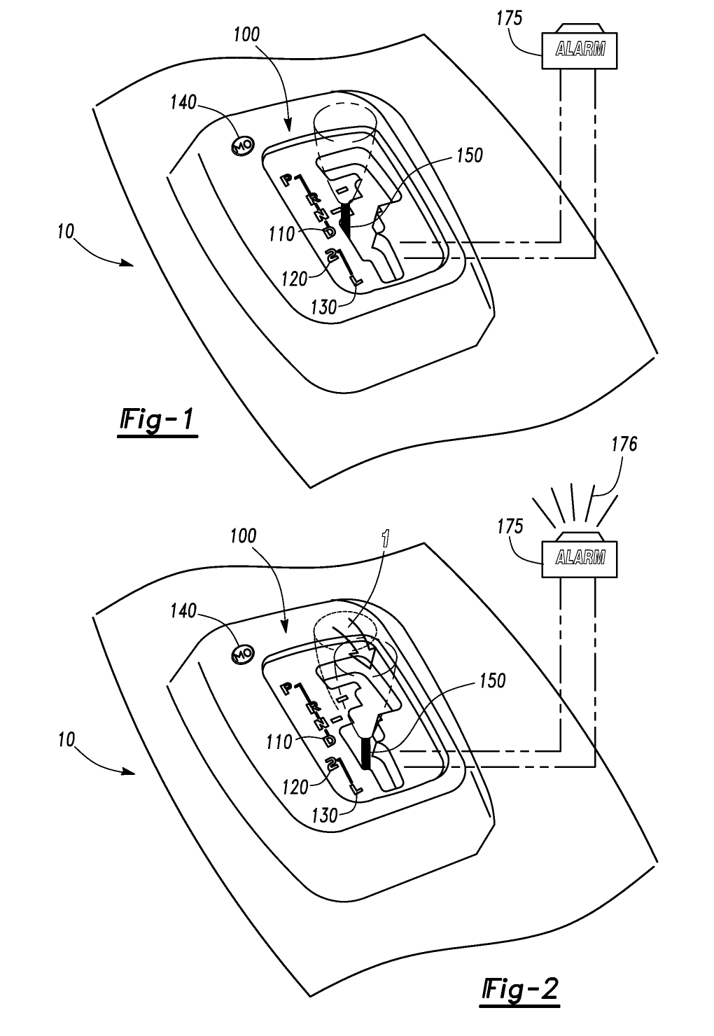

Turning now to FIGS. 1 and 2, an embodiment of the gear range selector is show generally at reference numeral 10. The gear range selector 10 includes a gear selector plate 100, a shift lever 150 and an alarm 175. The gear selector plate 100 can have a plurality of gear range positions, illustratively including Park (P), Reverse (R), Neutral (N), Drive (D), 2^{nd} (2) and Low (L). As shown in FIGS. 1 and 2, the gear selector plate 100 has a D position 110 representing the Drive gear range position, a 2 position 120 representing a 2^{nd}-gear range position and an L position 130 representing a 1^{st}-gear range position. As illustratively shown in FIG. 2, when the shift lever 150 is moved in a first direction 1 from the D position 110 to the 2 position 120, the alarm 175 is energized as represented by the signal 176. It is appreciated that the signal 176 can be in the form of a visual signal and/or an audible signal. It is also appreciated that the gear selector plate 100 and the plurality of gear range positions are for illustrative purposes only and that the exact shape and/or gear range positions can be different and still be within the scope of the invention so long as the gear range selector 10 affords for the energizing of the alarm 175 when the shift lever 150 is moved from Drive to a Drive-i position.

It is still further appreciated that a manual override can be included with the gear range selector 10, the manual override affording the driver of the motor vehicle to de-activate and/or de-energize the alarm 175 when desired. For illustrative purposes only, a manual override switch 140 is shown in FIGS. 1 and 2, however any type of manual override is within the scope of the present embodiment, for example a voice-activated manual override.

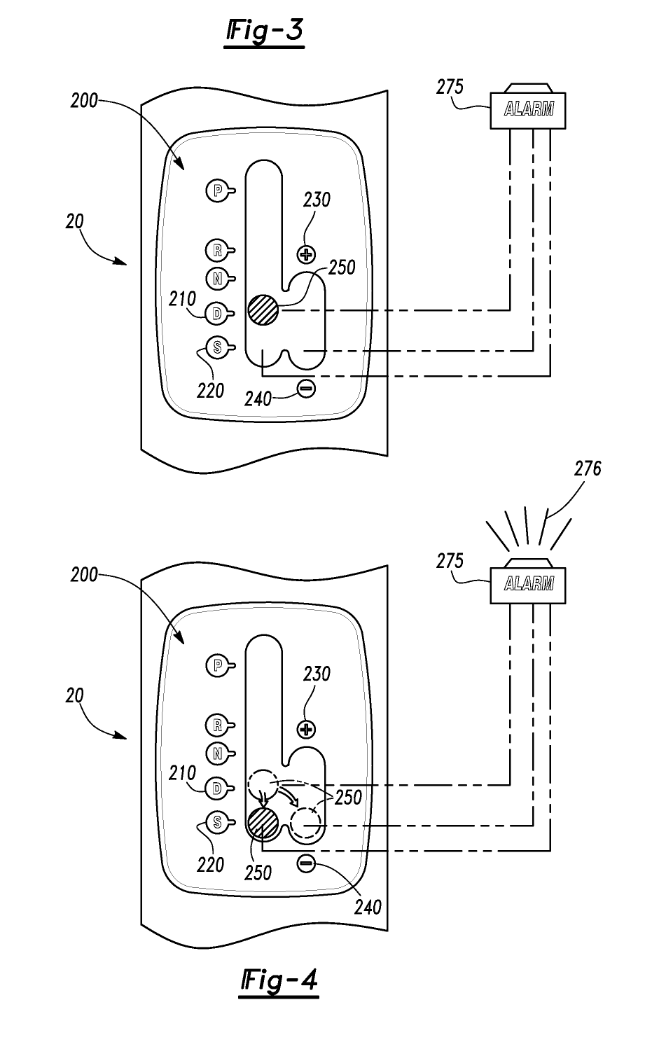

Turning now to FIGS. 3 and 4, another embodiment of a gear range selector is shown generally at reference numeral 20. The gear range selector 20 has a gear selector plate 200 with a Drive position 210 and a Sequential position 220. As shown in FIG. 4, a shift lever 250 can be moved from the Drive position 210 to one or more Sequential positions 220. The ‘+’ position 230 and the ‘−’ position 240 illustrate Sequential gear positions that afford the driver to select a gear range that is above/up or below/down a current gear range. When the shift lever 250 is moved from the Drive position 210 to one of the Sequential positions 220, an alarm 275 is energized and provides a signal 276. It is appreciated that a gear selector plate 200 can include a combination of Drive-i gear range positions and Sequential gear range positions. In such an event, an alarm could be energized when a shift lever is moved from Drive to Drive-i and/or Sequential.

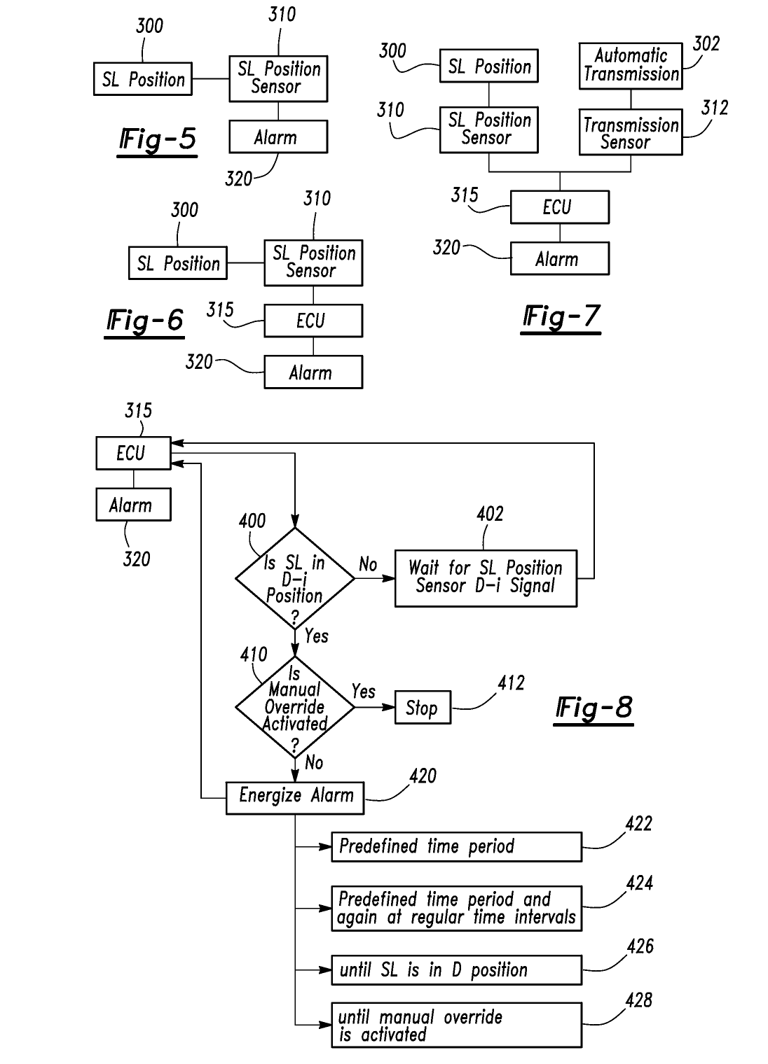

Turning now to FIG. 5, a schematic representation of a shift lever (SL) position 300, a SL position sensor 310 and an alarm 320 is shown. The SL position sensor 310 is operable to determine the position of the SL and if the SL is in a Drive-i position afford for energizing of the alarm 320.

Turning now to FIG. 6, an ECU 315 is added to the schematic representation shown in FIG. 5, the ECU 315 accepting a signal from the SL position sensor 310 and affording for the energizing of the alarm 320.

Turning now to FIG. 7, the ECU 315 can accept a signal from the SL position sensor 310 and a signal from a transmission sensor 312 that detects movement of an automatic transmission 302. It is appreciated that the transmission sensor 312 can detect from the automatic transmission 302 when the motor vehicle is moving in a forward direction. It is appreciated that other forward movement sensors known to those skilled in the art can be used within the scope of the present invention. When SL position sensor 310 and the transmission sensor 312 provide a signal to the ECU 315, the ECU 315 can afford for the energizing of the alarm 320 if a sequence of events has occurred. For example, FIG. 8 illustrates a logic diagram wherein the ECU 315 determines whether or not the SL is in a Drive-i position at step 400. If the SL is not in a Drive-i position, then the ECU 315 waits for a Drive-i signal from the SL position sensor at 402. In the alternative, if the ECU determines that the SL is in a Drive-i position, the ECU 315 determines whether or not a manual override of the SL position sensor 310 and/or the alarm 320 has been activated at step 410. If the manual override has been activated, then the ECU stops at 412 with respect to energizing the alarm 320 and/or waiting for a Drive-i signal from the SL position sensor 310. In the alternative, if the manual override has not been activated, the ECU 315 affords for the energizing of the alarm 320 at step 420. Reference numerals 422-428 illustrate that the ECU can afford for the energizing of the alarm 320 via different parameters. For example and for illustrative purposes only, the ECU 315 can energize the alarm 320 for a predefined time period 422 or for a predefined time period followed by re-energizing of the alarm at regular time intervals 424 until the SL is placed back into the Drive gear range position. In addition, the ECU 315 can afford for the energizing of the alarm 320 continuously until the SL is placed back into the Drive position 426 and/or until the manual override has been activated 428.

Thus, a number of possibilities and variations of the energizing of an alarm to alert a driver and/or occupant of a motor vehicle that a shift lever has been moved from a Drive position to a Drive-i position is provided. Such a gear range selector provides for an economical, simple and effective method for alerting a driver and/or an occupant of a motor vehicle that the shift lever has been moved or nudged from a desirable gear range position.

The invention is not restricted to the illustrative examples in the embodiments described above. The examples and embodiments are not intended as limitations on the scope of the invention. Methods, apparatus and the like described herein are exemplary and not intended as limitations on the scope of the invention. Changes therein and other uses will occur to those skilled in the art. The scope of the invention is described by the scope of the claims.

1. A gear range selector for a motor vehicle having an automatic transmission with more than one forward moving gear, said gear range selector comprising:
a gear selector plate having a Drive gear range position and at least one other forward movement gear range position;
a shift lever proximate said gear selector plate, said shift lever operable to be placed into said Drive gear range position or one of said other forward movement gear range positions; and
an alarm, said alarm operable to alert an occupant of the motor vehicle when said shift lever is placed into one of said other forward movement gear range positions.

2. The gear range selector of claim 1, further comprising a sensor operable to detect when said shift lever is placed into one of said other forward movement gear range positions.

3. The gear range selector of claim 2, wherein said alarm alerts the occupant of the motor vehicle when said sensor detects said shift lever is placed into one of said other forward movement gear range positions.

4. The gear range selector of claim 1, wherein one of said other forward movement gear range positions is selected from the group consisting of 5^{th} gear, 4^{th} gear, 3^{rd} gear, 2^{nd} gear, 1^{st} gear, Slow, Low, Sequential, Sequential Down, Sequential Up and combinations thereof.

5. The gear range selector of claim 1, wherein said alarm is an audible alarm.

6. The gear range selector of claim 1, wherein said alarm is a visual alarm.

7. The gear range selector of claim 1, wherein said alarm is an audible and visual alarm.

8. A gear range selector for a motor vehicle having an automatic transmission with more than one forward moving gear, said gear range selector comprising:
a gear selector plate having a Drive gear range position and at least one other forward movement gear range position;
a shift lever proximate said gear selector plate, said shift lever operable to be placed into said Drive gear range position or one of said other forward movement gear range positions;
a gear range position sensor, said sensor operable to detect when said shift lever is placed into one of said other forward movement gear range positions;
a motor vehicle movement sensor operable to detect when said motor vehicle is moving and stationary;
an alarm;
an electronic control unit in communication with said gear range sensor, said motor vehicle movement sensor and said alarm, said electronic control unit operable to energize said alarm when said gear range sensor detects said shift lever is placed in one of said other forward movement gear range positions and the motor vehicle is moving.

9. The gear range selector of claim 8, wherein one of said other forward movement gear range positions is selected from the group consisting of 5^{th} gear, 4^{th} gear, 3^{rd} gear, 2^{nd} gear, 1^{st} gear, Slow, Low, Sequential, Sequential Down, Sequential Up and combinations thereof.

10. The gear range selector of claim 8, wherein said alarm is an audible alarm.

11. The gear range selector of claim 8, wherein said alarm is a visual alarm.

12. The gear range selector of claim 8, wherein said alarm is an audible and visual alarm.

13. The gear range selector of claim 8, wherein said electronic control unit energizes said alarm after said gear range sensor detects said shift lever is placed in one of said other forward movement gear range positions, the motor vehicle is moving and a predetermined amount of time has elapsed.

14. The gear range selector of claim 8, wherein said electronic control unit energizes said alarm when said gear range sensor detects said shift lever is placed in one of said other forward movement gear range positions, the motor vehicle is moving and again after a predetermined amount of time has elapsed, unless said gear range sensor detects said shift lever is placed in said Drive gear range position.

15. The gear range selector of claim 14, wherein said electronic control unit energizes said alarm when said gear range sensor detects said shift lever is placed in one of said other forward movement gear range positions, the motor vehicle is moving and again at predetermined elapsed time intervals, until said gear range sensor detects said shift lever is placed in said Drive gear range position.

16. A gear range selector for alerting an occupant of a motor vehicle when a shift lever has been moved from a Drive gear position to another forward moving gear position while the motor vehicle is moving, the motor vehicle having an automatic transmission with a Drive selection and at least one other forward moving selection, said gear range selector comprising:
a gear selector plate having a Drive gear range position and at least one other forward movement gear range position;
a shift lever extending at least partially through said gear selector plate, said shift lever operable to be placed into said Drive gear range position or one of said other forward movement gear range positions; and
a gear range sensor, said sensor operable to detect when said shift lever is placed into one of said other forward movement gear range positions;
a motor vehicle movement sensor operable to detect when said motor vehicle is moving and stationary;
an alarm;
an electronic control unit in communication with said gear range sensor, said motor vehicle movement sensor and said alarm, said electronic control unit operable to energize said alarm when said gear range sensor detects said shift lever is placed in one of said other forward movement gear range positions and the motor vehicle is moving.

17. The gear range selector of claim 16, wherein one of said other forward movement gear range positions is selected from the group consisting of 5^{th} gear, 4^{th} gear, 3^{rd} gear, 2^{nd} gear, 1^{st} gear, Slow, Low, Sequential, Sequential Down, Sequential Up and combinations thereof.

18. The gear range selector of claim 16, wherein said alarm is selected from the group consisting of an audible alarm, a visual alarm and combinations thereof.

19. The gear range selector of claim 16, wherein said electronic control unit energizes said alarm after said gear range sensor detects said shift lever is placed in one of said other forward movement gear range position, the motor vehicle is moving and a predetermined amount of time has elapsed.

20. The gear range selector of claim 16, wherein said energizes said alarm when said gear range sensor detects said shift lever is placed in one of said other forward movement gear range positions, the motor vehicle is moving and again after a predetermined amount of time has elapsed unless said gear range sensor detects said shift lever is placed in said Drive gear range position.
